(19) United States
(12) Patent Application Publication
(10) Pub. No.: US 2016/0123042 A1
(43) Pub. Date: May 5, 2016

(54) FOOD STRAINER SECURITY DEVICE

(71) Applicant: Thomas HOMAN, JR., Somerdale, NJ (US)

(72) Inventor: Thomas HOMAN, JR., Somerdale, NJ (US)

(21) Appl. No.: 14/788,769

(22) Filed: Jun. 30, 2015

Related U.S. Application Data
(60) Provisional application No. 62/073,674, filed on Oct. 31, 2014.

(51) Int. Cl. E05B 73/00

(52) U.S. Cl. CPC E05B 73/00

(57) ABSTRACT

A device is provided that can be secured to an industrial kettle for preventing theft of the food being strained through its nozzle. The security device may form a security cavity for receiving at least a portion of the nozzle through an operative opening. Extending over the nozzle, and securing the security device thereto, is a security strap movable from a unlocked configuration to a locked configuration, preventing food product from being extricated from the security cavity. A plurality of slots are formed within the security cavity to fluidly communicate any liquid therein while preventing food product from being extricated through the plurality of slots.

### CROSS-REFERENCE TO RELATED APPLICATION

This application claims the benefit of priority of U.S. provisional application No. 62/073,674, filed 31 Oct. 2014, the contents of which are herein incorporated by reference.

### BACKGROUND OF THE INVENTION

The present invention relates to food strainers and, more particularly, to a device that can be secured to an industrial kettle for preventing theft of the food being strained there through.

While cooking in a correctional setting, where inmates participate in or at least have access to the cooking process, using the ubiquitous steam jacketed kettles with a faucet style drain has disadvantages. Specifically, inmates have the capability to steal contents of the kettle—food product (e.g., chicken, beef, pork, pasta)—by manipulating the strainer inside the kettle and draining the food product through the kettle faucet drain. Usually, there is a strainer that is used in the bottom of the kettle that can be relatively easily removed, undetected, using a cooking implement, such as a paddle or other stirring instrument. Such theft is a loss to the correctional institution. Moreover, the current industrial kettles in correctional institutions demand that the correctional officer has to sit, watch and wait for the food product to cook so as to ensure no such theft occurs.

As can be seen, there is a need for a device that can be secured to an industrial kettle for preventing theft of the food being strained there through.

### SUMMARY OF THE INVENTION

In one aspect of the present invention, a food strainer security device for industrial kitchen equipment includes at least one sidewall forming a securing cavity, wherein the securing cavity has at least one security opening; a plurality of slots formed in the at least one sidewall; a security strap extending from a first end to a distal end; and a pivotal connection joining the first end to a periphery of one security opening so that the security strap is movable from an unlocked configuration to a locked configuration, wherein the distal end engages a generally diametrically opposing portion of the periphery.

In another aspect of the present invention, food strainer security device for industrial kitchen equipment includes at least one sidewall forming a securing cavity, wherein the securing cavity has a security opening and an opposing closed end; an end wall covering the closed end; a plurality of slots formed in the at least one sidewall; a security strap extending from a first end to a distal end, wherein a portion of the security strap curves away from the security cavity; a pivotal connection joining the first end to a periphery of one security opening so that the security strap is movable from an unlocked configuration to a locked configuration, wherein the distal end engages a generally diametrically opposing portion of the periphery; a lock aperture formed into the distal end so that in the locked configuration the lock aperture and the bracket hole generally align; a lock bracket disposed near the diametrically opposed portion of the periphery; a bracket hole formed into the lock bracket; a lock dimensioned and adapted to operably engage the bracket hole and the lock aperture in the locked configuration; a slide ring disposed along the at least one sidewall; and a tether line attached to the slide ring.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention, demonstrating a locked configuration;

FIG. 3 is a perspective view of an exemplary embodiment of the present invention, demonstrating the locked configuration;

FIG. 4 is a perspective view of an exemplary embodiment of the present invention, demonstrating an unlocked configuration;

FIG. 5 is a section view of an exemplary embodiment of the present invention, taken along line 5-5 in FIG. 1; and

FIG. 6 is a section view of an exemplary embodiment of the present invention, taken along line 6-6 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a device that can be secured to an industrial kettle for preventing theft of the food through its nozzle. The security device may form a security cavity for receiving at least a portion of the nozzle through an operative opening. Extending over the nozzle, and securing the security device thereto, is a security strap movable from a unlocked configuration to a locked configuration, preventing food product from being extricated from the security cavity. A plurality of slots are formed within the security cavity to fluidly communicate any liquid therein while preventing food product from being extricated through the plurality of slots.

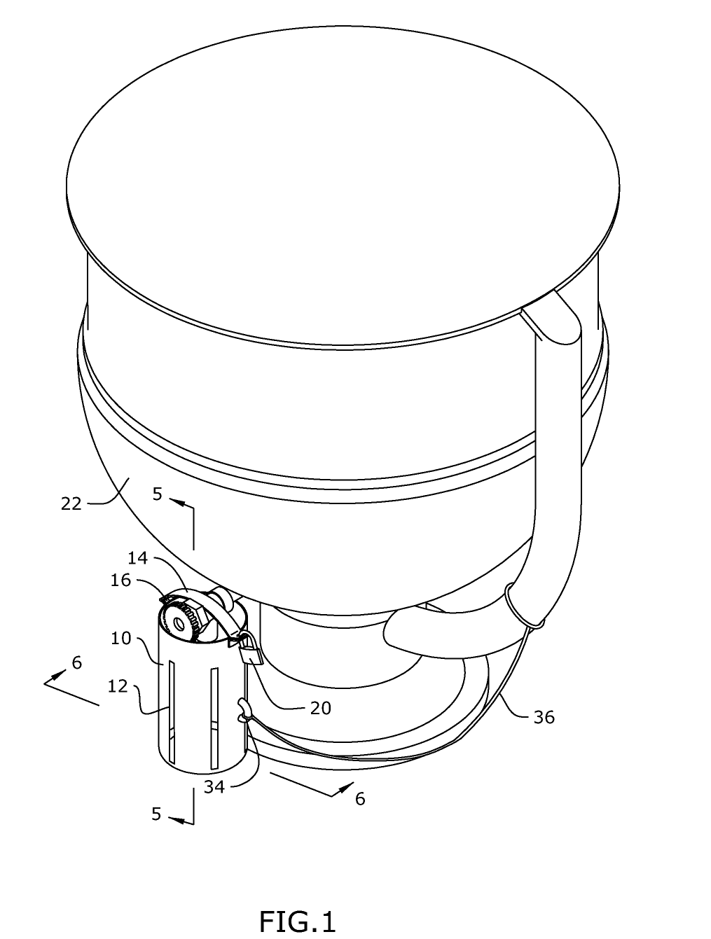

Referring to FIGS. 1 through 6, the present invention may include a security device 10 for securing a nozzle 24 of an industrial kettle 22 or any industrial kitchen equipment, thereby preventing theft of food product 26 through said nozzle 24. The security device 10 may include a plurality of walls forming a generally cylindrical shape, though any geometrical or non-geometrical shape may be suitable so long as the shape functions in accordance with the present invention as described herein. At least one of the plurality of walls may form a sidewall or sidewalls 40 forming a security cavity dimensioned and adapted for receiving at least a portion of the industrially-sized nozzle 24. At least one of the plurality of walls may form an end wall 42 closing one end of the security cavity, thereby leaving an operative opening 44 on the opposing end.

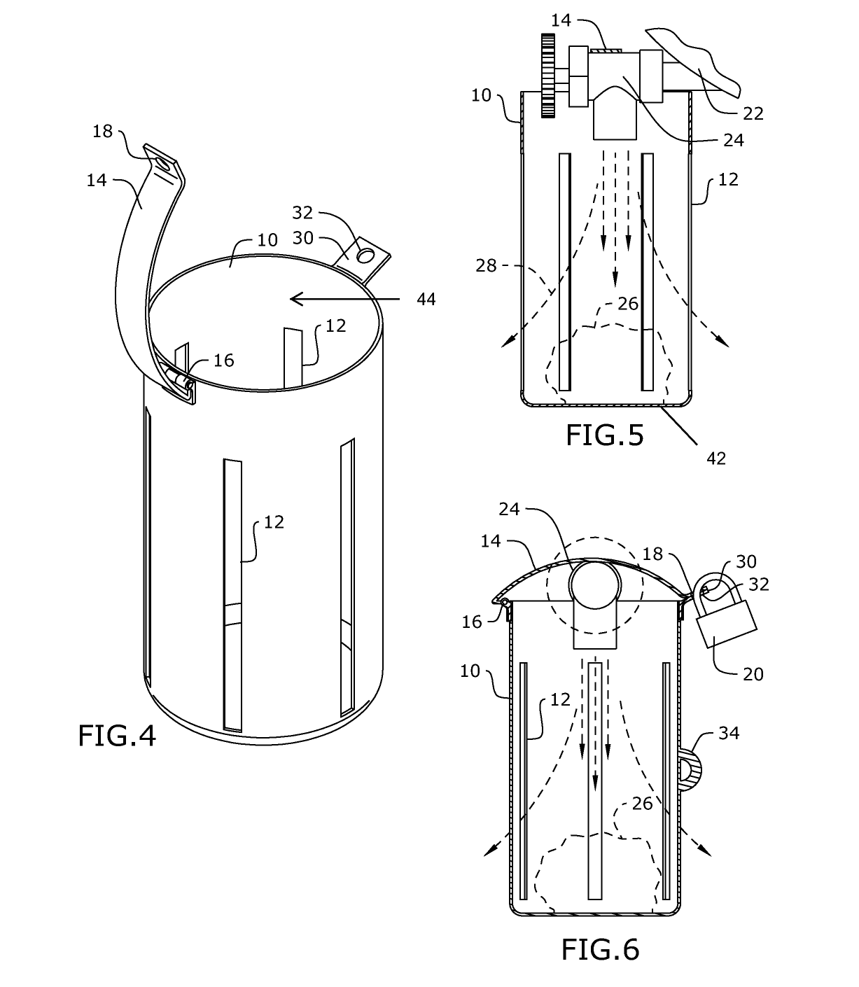

The sidewall(s) 40 and/or end wall 42 may form a plurality of slots 12, whereby each slot 12 is dimensioned and adapted for allowing the drainage and/or flow of a liquid 28, such as water, oil and like, while preventing the food product 26 from being extricated there through, as illustrated in FIGS. 5 and 6. The plurality of slots 12 may be holes, openings, apertures or other perforations.

A security strap 14 may extend from a first end to a distal end. The first end may be pivotally joined near a portion of a periphery of the operative opening 44 so that the distal end extends near to a diametrically opposed “lock portion” of the periphery of the operative opening 44. The pivotal connection may be facilitated by a hinge 16 or other suitable pivotal connection so that the security strap 14 is movable from an unlocked configuration to a lock configuration, preventing extrication of the food product 26 from the operative opening 44. The security strap 14 may be curved so that the curved portion extends above (as opposed to into) the security cavity, as illustrated in FIGS. 1 through 3. The security strap 14 may be dimensioned and adapted to secure the security device 10 to the nozzle 24, whereby access through the operative opening 44 is limited, preventing the food product 26 from the operative opening 44.

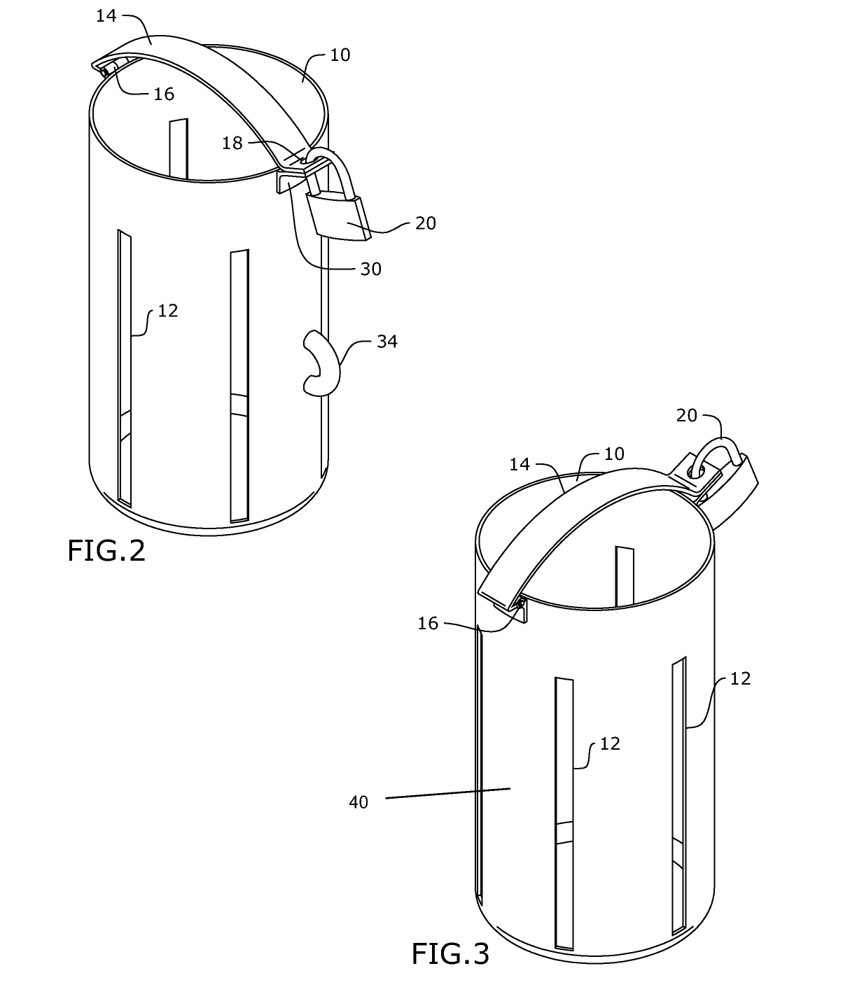

A lock aperture 18 may be disposed in the distal end of the security strap 14. A lock bracket 30 may be disposed along the periphery of the operative opening 44 near the lock portion. A bracket hole 32 may be disposed in the lock bracket 30 so that when the security strap 14 may be disposed in the locked configuration, the lock aperture 18 may align with the bracket hole, as illustrated in FIGS. 2 and 3. The aligned bracket hole 32 and lock aperture 18 may be secured by a lock 20, as illustrated in FIGS. 2 and 3.

A slide ring 34 may be disposed along the sidewall(s) 44. A tether line 36 may be attached to the slide ring 34 so as to extend to the industrial kettle 22, thereby preventing the security device 10 from being separated from the industrial kettle 22 beyond the extent of the tether line 36 or otherwise hold the security device 10 in place.

A method of using the present invention may include the following. The security device 10 disclosed above may be provided. A user interested in preventing theft of food product 26 through the nozzle 24, such as at a correctional institution, may move the security strap 24 from the unlocked configuration to the locked configuration so that the nozzle 24 is at least partially received within the security cavity and the security strap 14 operatively engages said nozzle 24. Then the user may the lock 20, such as a padlock, to further secure the security device 10 to the nozzle 24. Then the user may employ the nozzle 24 to urge the flow of the liquid 28 from the nozzle 24 and through the plurality of slots 12 so as to strain the contents of the kettle 22. If food product 26 were to pass through the nozzle 24, it would be restrained within the security cavity, as illustrated in FIGS. 5 and 6. In certain embodiments, this method of straining the food product 26 may allow the user to eliminate the use of an internal strainer of the kettle 22. In certain embodiments, an overall security system may include separately locking a lid of the kettle to secure the entire kettle 22, allowing the cook and/or supervising personnel/correction officers to not be constantly present.

It should be understood, of course, that the foregoing relates to exemplary embodiments of the invention and that modifications may be made without departing from the spirit and scope of the invention as set forth in the following claims.

What is claimed is:

1. A food strainer security device for industrial kitchen equipment, comprising:
at least one sidewall forming a securing cavity, wherein the securing cavity has at least one security opening;
a plurality of slots formed in the at least one sidewall;
a security strap extending from a first end to a distal end; and
a pivotal connection joining the first end to a periphery of one security opening so that the security strap is movable from an unlocked configuration to a locked configuration, wherein the distal end engages a generally diametrically opposing portion of the periphery.

2. The food strainer security device of claim 1, further comprising:
a lock bracket disposed near the diametrically opposed portion of the periphery;
a bracket hole formed into the lock bracket; and
a lock aperture formed into the distal end so that in the locked configuration the lock aperture and the bracket hole generally align.

3. The food strainer security device of claim 2, further comprising a lock dimensioned and adapted to operably engage the bracket hole and the lock aperture in the locked configuration.

4. The food strainer security device of claim 1, wherein the security strap forms a shape curving away from the security cavity.

5. The food strainer security device of claim 1, further comprising a slide ring disposed along the at least one sidewall.

6. The food strainer security device of claim 5, further comprising a tether line attached to the slide ring.

7. A food strainer security device for industrial kitchen equipment, comprising:
at least one sidewall forming a securing cavity, wherein the securing cavity has a security opening and an opposing closed end;
an end wall covering the closed end;
a plurality of slots formed in the at least one sidewall;
a security strap extending from a first end to a distal end, wherein a portion of the security strap curves away from the security cavity;
a pivotal connection joining the first end to a periphery of one security opening so that the security strap is movable from an unlocked configuration to a locked configuration, wherein the distal end engages a generally diametrically opposing portion of the periphery;
a lock aperture formed into the distal end so that in the locked configuration the lock aperture and the bracket hole generally align;
a lock bracket disposed near the diametrically opposed portion of the periphery;
a bracket hole formed into the lock bracket;
a lock dimensioned and adapted to operably engage the bracket hole and the lock aperture in the locked configuration;
a slide ring disposed along the at least one sidewall; and
a tether line attached to the slide ring.
